(19) United States
(12) Patent Application Publication
(10) Pub. No.: US 2008/0304710 A1
(43) Pub. Date: Dec. 11, 2008

(54) METHOD AND APPARATUS FOR PROCESSING IMAGE OF AT LEAST ONE SEEDLING

(76) Inventors: Lijie Xu, Columbus, OH (US); Miller B. McDonald, Powell, OH (US); Kikuo Fujimura, Palo Alto, CA (US)

Correspondence Address: CALFEE HALTER & GRISWOLD, LLP, 800 SUPERIOR AVENUE, SUITE 1400, CLEVELAND, OH, 44114, US

(21) Appl. No.: 11/760,148

(22) Filed: Jun. 8, 2007

(51) Int. Cl. G06K 9/00

(52) U.S. Cl. 382/110

(57) ABSTRACT

In one embodiment, a method of processing a source image of at least one seedling may include: a) segmenting the source image into at least a foreground portion and a background portion to form a segmented image, b) skeletonizing the segmented image to form a skeletonized image, the skeletonized image including a skeleton, c) dividing the skeleton into a plurality of segments, d) identifying alternate separations of the skeleton, each alternate separation including at least two groups, each group including at least one segment and potentially relating to a individual seedling, and e) evaluating a plurality of the alternate separations as a function of at least one of: 1) individual angles defined by connecting segments of corresponding groups, 2) combined angles defined by connecting segments of corresponding groups, 3) length defined by connecting segments of corresponding groups, and 4) unused segments.

### BACKGROUND

The Association of Official Seed Analysts (AOSA) defines seed vigour as “those seed properties which determine the potential for rapid, uniform emergence and development of normal seedlings under a wide range of field conditions.” Seed vigour is an important aspect of seed quality. However, it is difficult for seed analysts to efficiently and objectively quantify seed vigour. To address these difficulties, a Seed Vigor Imaging System (SVIS) was developed to provide a system that processes a seedling image to measure seedling length and automatically ranks seed lots for seed vigour. The SVIS has been critically evaluated in several types of crops, including lettuce (Lactuca sativa L.), soybeans (Glycine max [L.] Merr.), and melons (Cucumis melo L.). In each of these crops, seedling growth was measured fairly precisely if no seedlings were touching. However, when seedlings in a given image were overlapping, manual corrections were necessary. For additional information on the SVIS, see U.S. Pat. No. 6,882,740 to McDonald, Jr. et al.; Sako et al., A System for Automated Seed Vigour Assessment, Seed Science & Technology, Vol. 29, pp. 625-636 (2001); Contreras et al., Vigor Tests on Lettuce Seeds and Their Correlation With Emergence, Ciencia E Ivestigacion Agraria (on line) (in English), Vol. 32, No. 1, pp. 1-10 (January-April 2005); Hoffmaster et al., An Automated System for Vigor Testing Three-day-old Soybean Seedlings, Seed Science & Technology, Vol. 31, pp. 701-713 (2003); Hoffmaster et al., The Ohio State University Seed Vigor Imaging System (SVIS) for Soybean and Corn Seedlings, Seed Technology, Vol. 27, No. 1, pp. 7-26 (2005), and Marcos-Filho et al., Assessment of Melon Seed Vigor by an Automated Computer Imaging System Compared to Traditional Procedures, Seed Science & Technology, Vol. 34, No. 2, pp. 485-497 (July 2006). The contents of each of these references is fully incorporated herein by reference.

To minimize overlap in an image of seedlings, it has been recommended that overlapping seedlings be moved manually so they no longer touch before scanning the seedlings to an image. Nevertheless, processing the image to address the problem of overlapping seedlings is more desirable because moving seedlings by hand is a slow and tedious process. Informal studies have shown that moving seedlings for each replicate may take as long as two minutes by a skilled technician and this additional time makes the test economically unacceptable. In addition, moving seedlings can result in breaking fragile roots, particularly for small-seeded crops. Obviously, any damage to roots may result in test errors. A solution that could process a seedling image to resolve overlapping seedlings may reduce the time required for seed vigour analysis, may reduce test errors, and may improve overall seed vigour evaluation by imaging systems, such as SVIS.

### SUMMARY

In one aspect a method of processing a source image of at least one seedling is provided, each seedling being associated with a type of crop. In one embodiment, the method including: a) segmenting the source image into at least a foreground portion and a background portion to form a first segmented image, the foreground portion relating to the at least one seedling, b) skeletonizing the first segmented image to form a first skeletonized image, the first skeletonized image including a skeleton relating to the foreground portion of the first segmented image, c) dividing the skeleton in the first segmented image into a plurality of segments, d) identifying alternate separations of the skeleton, each alternate separation including at least two groups, each group including at least one segment and potentially relating to a individual seedling, and e) evaluating a plurality of the alternate separations as a function of at least one of: 1) individual angles defined by connecting segments of corresponding groups, 2) combined angles defined by connecting segments of corresponding groups, 3) length defined by connecting segments of corresponding groups, and 4) unused segments.

### DRAWINGS

These and other features, aspects, and advantages of the present invention will become better understood with regard to the accompanying drawings, following description, and appended claims.

FIG. 1A is a perspective view of an exemplary embodiment of an imaging system;

FIG. 1B is a block diagram of an exemplary embodiment of an imaging system;

FIG. 2 is a flow chart of an exemplary embodiment of processing an image of seedlings;

FIG. 3 is a histogram of an exemplary image of seedlings to be processed;

FIG. 4 is a graph depicting an exemplary segmentation process for an image of seedlings;

FIG. 5 is a flow chart of another exemplary process for processing an image of seedlings;

FIG. 6 shows several examples of source images with overlapping seedlings and various stages of processing the source images;

FIG. 7 shows another example of a source image with overlapping seedlings and various of processing the source image;

FIG. 8 shows an exemplary embodiment of a process for identifying multiple possible separations of a skeleton during processing of an image of seedlings;

FIG. 9 shows an exemplary embodiment of a process for evaluating multiple possible separations of a skeleton during processing of an image of seedlings; and

FIG. 10 compares results from processing several exemplary images of seedlings using a previous image processing system with corresponding results from processing the exemplary images using an exemplary embodiment of image processing described herein.

### DESCRIPTION

The following paragraphs include definitions of exemplary terms used within this disclosure. Except where noted otherwise, variants of all terms, including singular forms, plural forms, and other affixed forms, fall within each exemplary term meaning. Except where noted otherwise, capitalized and non-capitalized forms of all terms fall within each meaning.

“Circuit,” as used herein includes, but is not limited to, hardware, firmware, software or combinations of each to perform a function(s) or an action(s). For example, based on a desired feature or need, a circuit may include a software controlled microprocessor, discrete logic such as an application specific integrated circuit (ASIC), or another programmed logic device. A circuit may also be fully embodied as software. As used herein, “circuit” is considered synonymous with “logic.”

“Comprising,” “containing,” “having,” and “including,” as used herein, except where noted otherwise, are synonymous and open-ended. In other words, usage of any of these terms (or variants thereof) does not exclude one or more additional elements or method steps from being added in combination with one or more delineated elements or method steps.

“Computer component,” as used herein includes, but is not limited to, a computer-related entity, either hardware, firmware, software, a combination thereof, or software in execution. For example, a computer component can be, but is not limited to being, a processor, an object, an executable, a process running on a processor, a thread of execution, a program and a computer. By way of illustration, both an application running on a server and the server can be computer components. One or more computer components can reside within a process or thread of execution and a computer component can be localized on one computer or distributed between two or more computers.

“Computer communication,” as used herein includes, but is not limited to, a communication between two or more computer components and can be, for example, a network transfer, a file transfer, an applet transfer, an email, a hypertext transfer protocol (HTTP) message, a datagram, an object transfer, a binary large object (BLOB) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Controller,” as used herein includes, but is not limited to, any circuit or device that coordinates and controls the operation of one or more input or output devices. For example, a controller can include a device having one or more processors, microprocessors, or central processing units (CPUs) capable of being programmed to perform input or output functions.

“Logic,” as used herein includes, but is not limited to, hardware, firmware, software or combinations of each to perform a function(s) or an action(s), or to cause a function or action from another component. For example, based on a desired application or need, logic may include a software controlled microprocessor, discrete logic such as an application specific integrated circuit (ASIC), or other programmed logic device. Logic may also be fully embodied as software. As used herein, “logic” is considered synonymous with “circuit.”

“Measurement,” as used herein includes, but is not limited to, an extent, magnitude, size, capacity, amount, dimension, characteristic or quantity ascertained by measuring. Example measurements may be provided, but such examples are not intended to limit the scope of measurements that the systems and methods described herein can employ.

“Operative communication,” as used herein includes, but is not limited to, a communicative relationship between devices, logic, or circuits, including mechanical and pneumatic relationships. Direct and indirect electrical, electromagnetic, and optical connections are examples of connections that facilitate operative communications. Linkages, gears, chains, belts, push rods, cams, keys, attaching hardware, and other components contributing to mechanical relations between items are examples of components facilitating operative communications. Pneumatic devices and interconnecting pneumatic tubing may also contribute to operative communications. Two devices are in operative communication if an action from one causes an effect in the other, regardless of whether the action is modified by some other device. For example, two devices separated by one or more of the following: i) amplifiers, ii) filters, iii) transformers, iv) optical isolators, v) digital or analog buffers, vi) analog integrators, vii) other electronic circuitry, viii) fiber optic transceivers, ix) Bluetooth communications links, x) 802.11 communications links, xi) satellite communication links, and xii) other wireless communication links. As another example, an electromagnetic sensor is in operative communication with a signal if it receives electromagnetic radiation from the signal. As a final example, two devices not directly connected to each other, but both capable of interfacing with a third device, e.g., a central processing unit (CPU), are in operative communication.

“Or,” as used herein, except where noted otherwise, is inclusive, rather than exclusive. In other words, “or’ is used to describe a list of alternative things in which one may choose one option or any combination of alternative options. For example, “A or B” means “A or B or both” and “A, B, or C” means “A, B, or C, in any combination.” If “or” is used to indicate an exclusive choice of alternatives or if there is any limitation on combinations of alternatives, the list of alternatives specifically indicates that choices are exclusive or that certain combinations are not included. For example, “A or B, but not both” is used to indicate use of an exclusive “or” condition. Similarly, “A, B, or C, but no combinations” and “A, B, or C, but not the combination of A, B, and C” are examples where certain combinations of alternatives are not included in the choices associated with the list.

“Processor,” as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random access memory (RAM), read-only memory (ROM), programmable read-only memory (PROM), erasable programmable read-only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

“Root,” as used herein includes, but is not limited to, the anatomical seedling structures of the hypocotyl and root except where noted otherwise.

“Signal,” as used herein includes, but is not limited to, one or more electrical signals, including analog or digital signals, one or more computer instructions, a bit or bit stream, or the like.

“Software,” as used herein includes, but is not limited to, one or more computer readable or executable instructions that cause a computer or another electronic device to perform functions, actions, or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system, or other types of executable instructions. It will be appreciated by one of ordinary skill in the art that the form of software is dependent on, for example, requirements of a desired application, the environment it runs on, or the desires of a designer/programmer or the like.

“Software component,” as used herein includes, but is not limited to, a collection of one or more computer readable or executable instructions that cause a computer or other electronic device to perform functions, actions or behave in a desired manner. The instructions may be embodied in various forms like routines, algorithms, modules, methods, threads, or programs. Software components may be implemented in a variety of executable or loadable forms including, but not limited to, a stand-alone program, a servelet, an applet, instructions stored in a memory, and the like. Software components can be embodied in a single computer component or can be distributed between computer components.

The following table includes long form definitions of exemplary acronyms used within this disclosure. Except where noted otherwise, variants of all acronyms, including singular forms, plural forms, and other affixed forms, fall within each exemplary acronym meaning. Except where noted otherwise, capitalized and non-capitalized forms of all acronyms fall within each meaning.

| Acronym | Long Form |
|---|---|
| AOSA | Association of Official Seed Analysts |
| ASIC | Application specific integrated circuit |
| BLOB | Binary large object |
| CPU | Central processing unit |
| DBMS | Database management system |
| DSP | Digital signal processor |
| EPROM | Erasable programmable read-only memory |
| HSV | Hue, saturation, and value (hue-saturation-value) |
| HTTP | Hypertext transfer protocol |
| LAN | Local area network |
| PC | Personal computer |
| PROM | Programmable read-only memory |
| RAM | Random access memory |
| RGB | Red, green, and blue (red-green-blue) |
| ROM | Read-only memory |
| SVIS | Seed Vigor Imaging System |
| WAN | Wide area network |

When multiple seedlings are touching (e.g., when any portion of one seedling is adjoining or crossing over or under another seedling) each other in any manner when the seedlings are imaged they are said to overlap. In general, various embodiments of an apparatus and method described herein provide an approach to automatically resolve overlapping seedlings through image processing techniques that allow imaged seedlings to be individually measured. Individual seedling lengths can then be used to calculate growth and uniformity values that determine the overall vigour index for the corresponding lot of seed. More specifically, various embodiments of a method and apparatus of processing an image of seedlings described herein includes processing the image to separate overlapping seedlings.

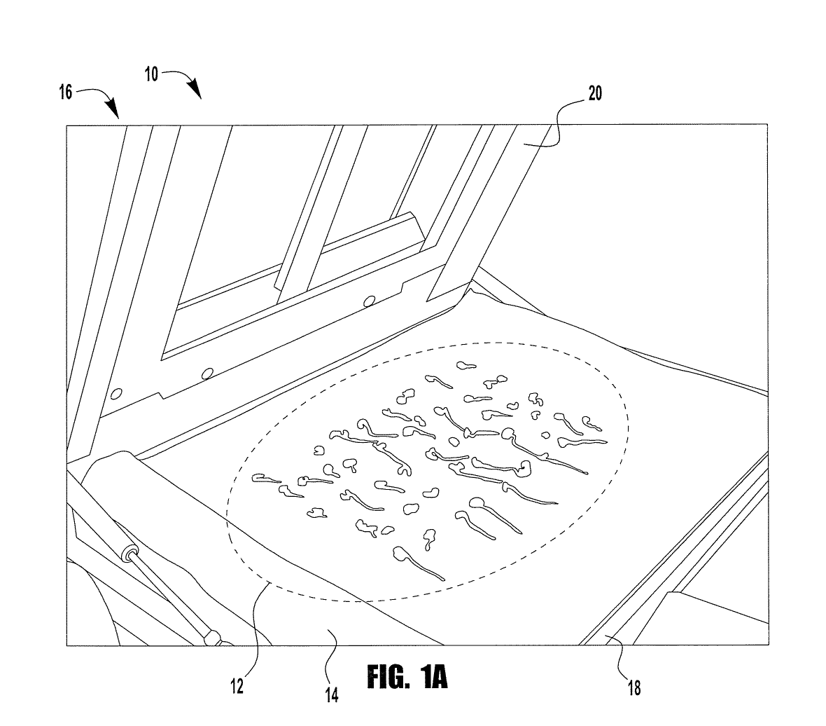

With reference to FIG. 1, using an exemplary imaging system 10, germinated seedlings 12 on a paper towel 14 may be imaged to provide one or more scanned images. These scanned images can provide the initial input data for image processing. The length of individual seedlings in a given scanned image may be measured during the image processing. An overall vigour index based on seedling length data may be provided as an initial output from the image processing. If overlapping seedlings are detected, an algorithm may be activated to separately identify each seedling and measure each separated seedling independently. The algorithm may use concepts similar to network optimization to select an optimal solution.

In one exemplary study, cotton seedlings 12 were used to illustrate this approach. It is understood that the algorithm can be applied to other types of crops as well. In the exemplary study, cotton (Gossypium hirsutum L.) seeds provided by Delta and Pine Land Company of Scott, Miss. were used throughout in the study. The cotton seeds were germinated in the dark on moistened, rolled paper towels 14 in a germinator at 25° C. for seven days.

Before scanning, the paper towels 14 were moistened to ensure a uniform background in the acquired images. A scanner 16, such as an Epson Scanner, Model GT-15000, was used to provide both a large scanning area (29.7×43.2 cm) and fast scanning speed. The scanner 16 was placed inside a scanning box with the scanning surface 18 facing down and attached on one side to a bottom surface 20 such that the scanning surface 18 could be raised on one side to an open position and closed for scanning. The paper towels 14 were unrolled and placed on the bottom surface 20. The germinated seedlings 12 were placed on the paper towels 14 so that they would be facing the scanning surface 18 during scanning. Use of the scanning box facilitates ease of unrolling the paper towels 14 and also creates a relatively stable lighting condition to obtain uniform backgrounds in the images. All scanning was at 100 dpi resolution. The corresponding computer for the imaging system 10 was a Toshiba Protege with a Pentium IV processor and 512 MB of memory. In other embodiments, various arrangements of other types of scanners, computers, and computer components may be implemented to provide suitable scanned images. The scanned images were in JPEG format and had a resolution of 1700×1200 pixels. The image file size was about 200 KB. In other embodiments, different types of image files, different resolutions, and different file sizes may be used as long as suitable source images for image processing are produced.

For the exemplary study, image processing software was developed using Visual C++ 6.0. In other embodiments, other software programming languages may be used to develop suitable image processing software. The initial input data to be processed by the image processing software was color image data from source images of the seedlings acquired by the Epson scanner. In other embodiments, the image data may be represented in grey scale or any color space that suitably distinguishes the objects of interests in the source image for the image processing software. The imaging system 10 may process the source images and determine individual lengths of seedlings and a vigour index value. These results may be saved, for example, in a Microsoft Access database file on a storage device associated with the computer. In other embodiments, the results may be saved in other file formats or on any storage device with which the computer is in communication. Additionally (or alternatively), the results may be displayed on a display device associated with the computer or printed on a printing device associated with the computer. The image processing and determining of the vigor index are described in more detail below. The various aspects of FIG. 1A described herein may be implemented through hardware, software, firmware, or combinations thereof.

After the imaging system 10 used for the exemplary study was assembled and the image processing software installed, a calibration procedure was performed to ensure measurements would be suitably accurate and precise. An exemplary calibration routine may take into account different types of hardware configurations, scanner settings, and different sizes or arrangements for scanning boxes. For example, the distance between the scanning screen 20 and paper towels 14 may be different from system to system and may affect the size of the seedlings in the image. Re-calibration may not be necessary unless hardware or scan settings are changed. In the exemplary study, calibration was performed as follows: i) a ruler was scanned at 100 dpi, ii) a straight 1-inch line was drawn on the ruler image, for example, from 0 to 1, iii) the ruler image with the 1-inch line was scanned, and iv) image processing software was used to measure the set the result to an x (e.g., 1-inch) reference measurement. If the reference measurement is x units, this value may be associated with the real length of the line (e.g., x units, 1 inch). A linear correction formula may be derived from the calibration and saved for use in establishing units of measure for measurements resulting from image processing. The calibration procedure may allow up to five measurements and corresponding associations to provide some degree of error correction caused by any particular reading. For example, reference measurements can be taken for ¼ inch, ½ inch, 1 inch, 2 inches, and 4 inches during the calibration routine.

With reference to FIG. 1B, an exemplary embodiment of an image processing system 30 for processing an image of potentially overlapping seedlings may include a computer 32, an input device 34, a display device 36, and one or more storage devices 38. In other embodiments, the image processing system 30 may also include a scanning device 40 or a printing device 42. The computer 32, input device 34, display device 36, storage device(s) 38, scanning device 40, and printing device 42 may be arranged to form a standalone computer system, such as a personal computer (PC) or the like. In other embodiments, the computer and associated devices may be located at various locations and in communication via one or more communication networks, such as a LAN, WAN, telephone network, cable television (TV) network, wireless network, etc.

The computer 32 may include a processor 44 and a memory 46. The storage device(s) 38 may include an image processing software application 48, one or more image files 50, a database management software (DBMS) application 52, and one or more database files 54 in various combinations. The input device 34 may include a keyboard, pointing device, or any type of one or more control devices suitable for controlling operation of the computer 32. The memory 46 may include any suitable combination of RAM, ROM, or other types of memory to support operation of the processor 44 and its running of the image processing or DBMS software 48, 52. Each of the image processing software application 48, image file(s) 50, DBMS application 52, and database file(s) 54 may be stored on one or more storage devices. For example, in one embodiment, they may be stored on the same storage device. In another embodiment, the image processing software and DBMS applications 48, 52 may be stored on a first storage device, the image file(s) 50 may stored on second and third storage devices, and the database file(s) 54 may be stored on a fourth storage device.

The processor 44 may run the image processing software 48 to process a source image. The source image may be provided by the scanning device 40 or from the image file(s) 50 within the storage device(s) 38. Normally the source image includes one seedling. However, sometimes the source image includes two or more seedlings and at least two of the two or more seedlings may be touching (i.e., overlapping). The image processing software 48 may include processes that identify and separate overlapping seedlings into individual seedlings for purposes of determining individual lengths of seedlings and a vigour index value. Intermediate results from the identification and separation of overlapping seedlings, for example, may be stored as intermediate images in the image file(s) 50 or as intermediate data in the database file(s) 54. Similarly, final results from the determining of seedling length and vigour index, for example, may be stored as results data in the database file(s) 54. In another embodiment, the image processing software 48 may interact with the DBMS application 52 via the processor 44 to store results in the database file(s) 54. In other embodiments, the intermediate and final results may alternatively or additionally be provided to the display device 36 or printing device 42.

The image processing software 48 may retrieve one or more image(s) from the image file(s) 50 for display on the display device 36 or for rendering by the printing device 42. Similarly, the processor 44 may run the image processing or DBMS software 48, 52 to retrieve data from the database file(s) 54 for display on the display device 36 or for rendering by the printing device 42. The various aspects of FIG. 1B described herein may be implemented through hardware, software, firmware, or combinations thereof.

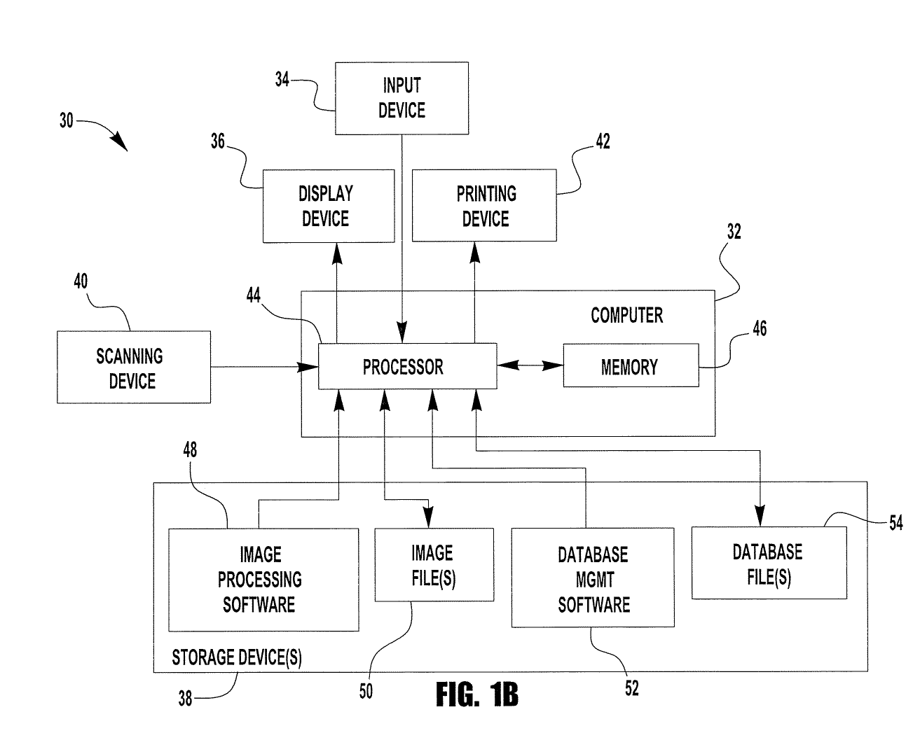

With reference to FIG. 2, an exemplary embodiment of a process 100 for seedling image processing includes a start 102, a preprocessing stage 104, an overlap processing stage 106, and an end 108. The preprocessing stage 104 may include a segmentation element 110 and a skeletonization element 112 in any sequence. The overlap processing stage 106 may include an overlap detection element 114, a network pruning element 116, or a network optimization element 118, in any combination and sequence.

The segmentation element 110 may receive a source image as input data and may segment the image into foreground (i.e., seedling) pixels and background pixels. The seedling pixels may be further segmented into seed coat pixels and root pixels. For example, a seedling, particularly a root portion of a seedling, may be identified by its brightness. Additionally, a seed coat may be identified by its color. For example, the seed coat of normal cotton seeds is usually black or may be altered with a particular colorant by a vendor to indicate a particular variety, seed treatment, genetic trait, or another seed characteristic. The cotton seeds from Delta and Pine Land Company used in the exemplary study were treated with a colorant so that the seed coats were colored blue. A light seedling (especially its root portion) may be extracted from a darker background based on its brightness. For each source image, a global threshold may be determined by statistical analysis because the background is relatively dark in comparison to the one or more seedlings and the background occupies the majority of the image. Pixels that are brighter than the threshold may be marked or classified as seedling pixels, pixels that are darker may be marked or classified as background pixels. The seedling pixels include pixels defining the root portion of each seedling and may include pixels from the seed coat portion of a given seedlings. The background pixels, for example, represent the paper towels upon which the seedlings were placed and may include pixels from the seed coat portion of a given seedling. Further preprocessing may be performed to segment the seed coat pixels from the root pixels and background pixels. The various aspects of FIG. 2 described herein may be implemented through hardware, software, firmware, or combinations thereof.

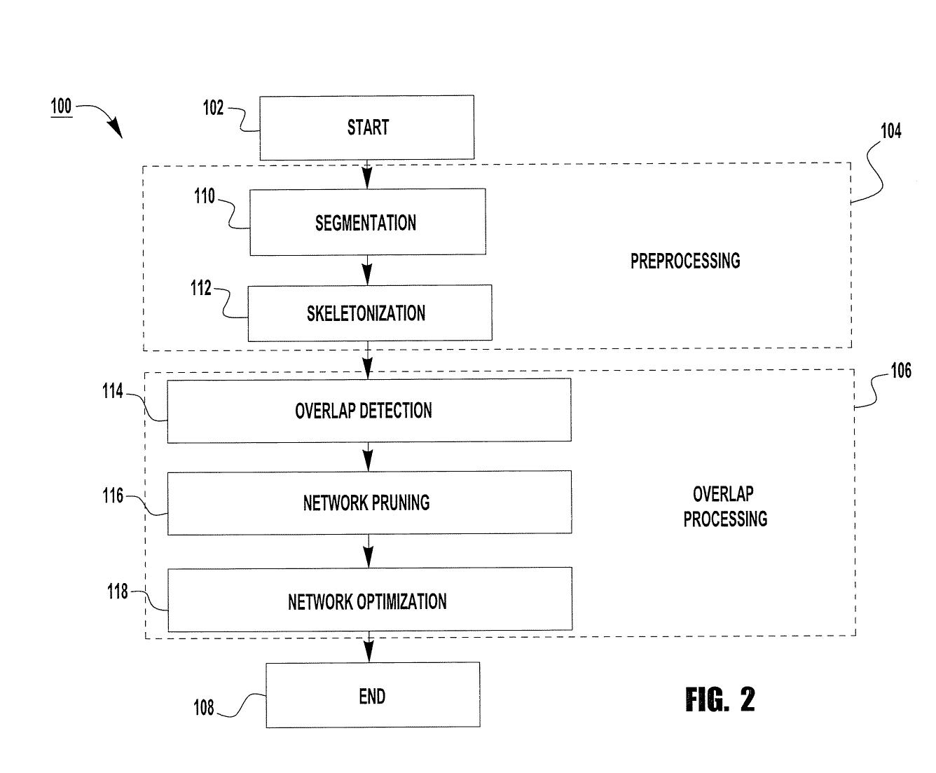

FIG. 3 shows a histogram 120 of an source image. The x axis 122 represents gray scale values from 0 to 255. The y axis 124 represents quantity of pixels in 10,000 s. The largest peak or hump 126 in the histogram 120 corresponds to the gray scale value for the background pixels. Mean (μ) 128 and variance (σ) 130 of the gray scale values were calculated and the threshold value 132 was calculated by the formula μ+_{.} weight * σ,_{..} where the weight is a user-defined constant. For example, the weight used in the exemplary study was 1.0. Thus, for the histogram 120 of FIG. 3, the calculated threshold value (ref. no. 132) was 150. For each source image, a different threshold value 132 may be determined. Re-calculation of thresholds for each source image may provide more precise segmentation.

As mentioned above, a seed coat may be identified by its color. During segmentation, the source image may be transformed, for example, from a conventional red-green-blue (RGB) color space to a hue-saturation-value (HSV) color space. The HSV color space includes three channels; namely hue, saturation, and value. The hue channel includes color information and may be used to identify seed coat pixels. The various aspects of FIG. 3 described herein may be implemented through hardware, software, firmware, or combinations thereof.

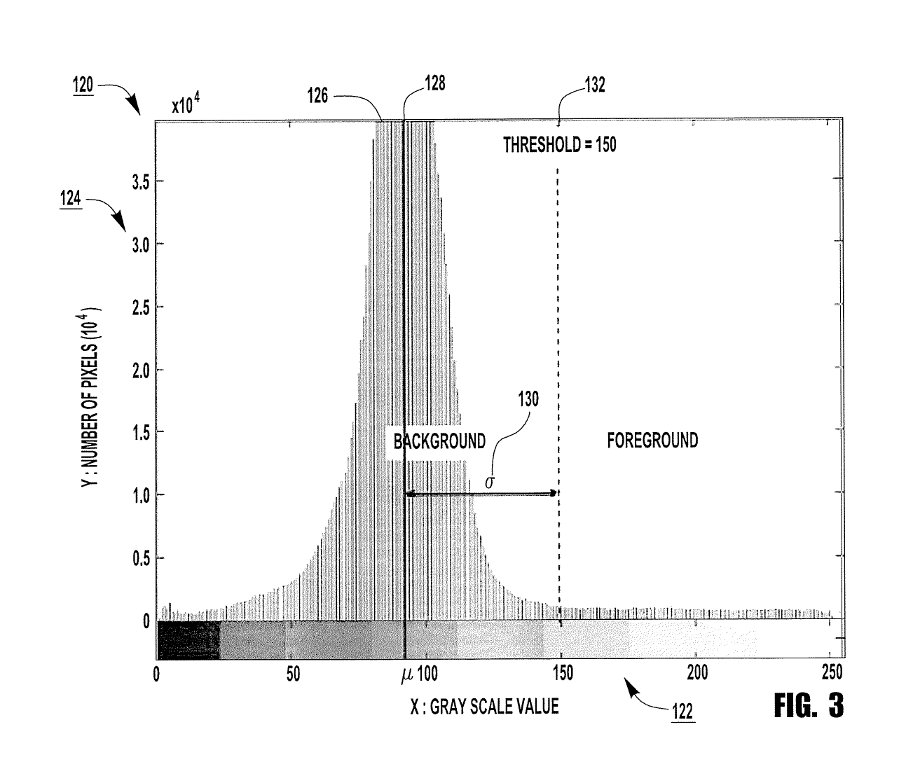

With reference to FIG. 4, an example of segmentation of seed coats from the background is shown using the hue channel in a saturation-hue channel graph 140 of pixels from a source image represented in the HSV color space. For a source image in which the seed coats are a different color (i.e., higher or lower hue), a different separation line may be derived for classifying background pixels from seed coat pixels by evaluating a cluster of points associated with the new seed coat color and the cluster of points associated with the background. In this example, the hue of the seed coat pixels may be nicely separated from the background pixels by a first vertical line 142 where the hue is 0.2. However, because of shadows or highlights on the seed coat, there may be noise data that does not represent the true seed coat color. Thus, in this example, using the first vertical line 142 at a hue of 0.2 as the threshold for classifying between background and seed coat pixels may lead to an over-fitting problem where, even though the classifier may work well for the training set, it may fail for an unacceptable amount of source images. To avoid this, two ellipses 144, 146, enclosing 90% data from the two clusters, respectively, may be fitted to the clusters in the hue-saturation graph. A second vertical line 148 at a hue of 0.3 may be a better threshold for classification between background and seed coat pixels because it is generally at a mid-point between the two ellipses 144, 146. As a result, pixels in the HSV color space with a hue greater than 0.3 may be classified as seed coat pixels. The various aspects of FIG. 4 described herein may be implemented through hardware, software, firmware, or combinations thereof.

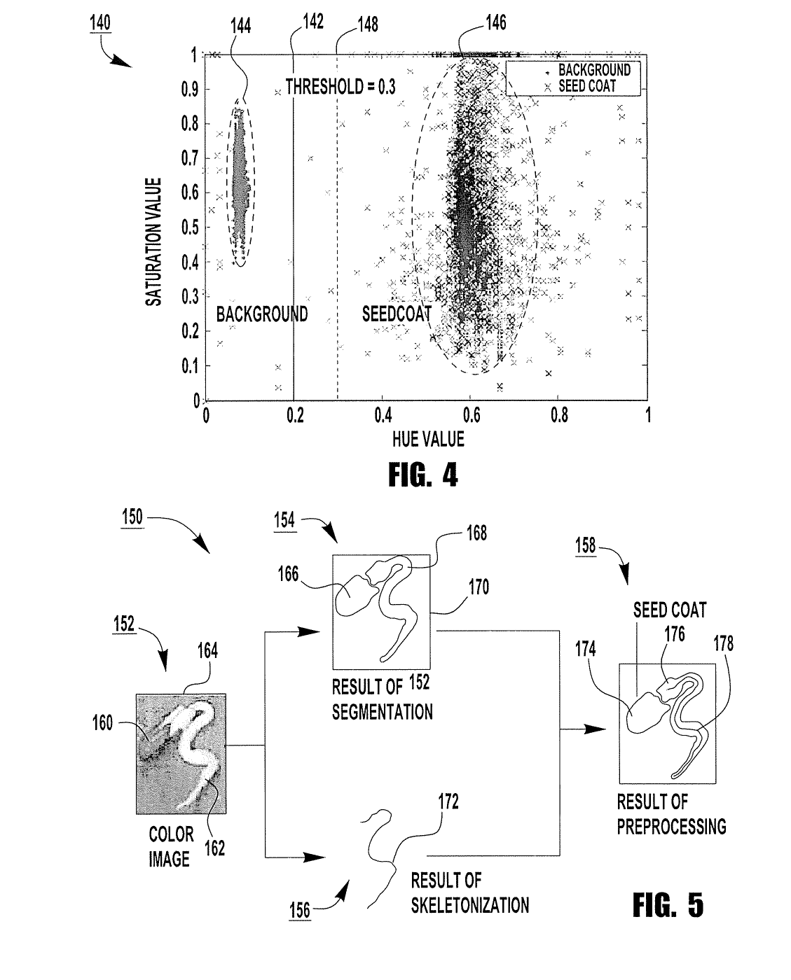

With reference to FIG. 5, an embodiment of an image preprocessing stage 150 may receive a source image 152 and may perform segmentation resulting in a segmented image 154 and skeletonization resulting in a skeletonized image 156. The combination of segmentation and skeletonization resulting in a preprocessed image 158. The source image 152 may include at least one seedling with a seed coat 160 generally represented by a first color and a root 162 generally represented by a second color. The second color may be generally distinguishable from the first color. The source image 152 may show that each seedling is placed on, for example, a paper towel 164 generally represented by a third color defining a background. The third color may be generally distinguishable from the first and second colors.

The segmented image 154 may include first-colored pixels that may represent seed coats 160 as seed coat portions 166, second-colored pixels that may represent roots 162 as root portions 168, and third-colored pixels that may represent the paper towel 164 as a background 170. For example, the first-colored pixels may be gray, the second-colored pixels may be white, and the third-colored pixels may be black. In other embodiments, the pixels for any of the seed coat portions 166, root portions 168, or background 170 may be set to other colors suitable for generally distinguishing between these seed coat, root, and background classes. Segmentation of one or more root portions 168, for example, may be accomplished as discussed above in conjunction with the description of FIG. 3. Segmentation of the seed coat portion 166, for example, may be accomplished as discussed above in conjunction with the description of FIG. 4.

The number of seed coats segmented from a given image may provide assistance in predicting the quantity of seedlings for the overlap processing stage of that image. For example, the number of seed coats may be used as an initial value for the expected quantity of seedlings when determining whether or not there are any overlapping seedlings. Cotyledons (i.e., the first leaves, first pair of leaves, or first whorl of leaves), which may break apart the seed coat (or push the seed coat off of the seedling), may not necessarily be considered during the image processing. Therefore, in case some seed coats had already sloughed off the seedling, the initial value for the quantity of seedlings may be increased by an amount so that the estimated total number of seedlings is more likely to meet or exceed the actual number of seedlings. In other embodiments, this increase may not be necessary. In still other embodiments, the amount of the increase may be based on empirical data or on any suitable basis that makes it more likely that the estimated total number of seedlings is greater than or equal to the actual number of seedlings.

Skeletonization (also known as image thinning) may be carried out on each root portion 168 in the source image. Each root portion 168 may be reduced until a one-pixel wide skeleton 172 remains. In other embodiments, the width of the skeleton may be different as long as its length is suitable for measurement. The length of each root portion 168 may be measured, for example, by counting the number of pixels in the skeleton 172 to determine an initial length estimate for each seedling.

The skeletonized image 156 resulting from skeletonization shows the skeleton 172 associated with the root portion 168 of the seedling. The preprocessed image 158 resulting from the combination of segmentation and skeletonization may include a seedling with a seed coat portion 174, a root portion 176, and a skeleton 178. FIG. 5 shows images at various points of the image preprocessing stage 150. Overlap processing, for example, may be performed to further process the skeletons and adjust the measured length of each seedling for overlapping conditions.

With reference again to FIG. 2, overlap processing 106 may include overlap detection 114 to detect overlapping seedlings. Implementing certain rules associated with overlap detection may reduce the time taken in running the overlap detection algorithm on non-overlapping cases. For example, one may assume that non-overlapping seedlings do not branch. Therefore, two or more seedlings may be overlapping if either: i) a corresponding skeleton resulting from the skeletonization 112 includes any branches (Rule 1) or ii) more than one seed coat resulting from the segmentation 110 is connected to the corresponding skeleton (Rule 2).

To check for Rule 1, a walk may be taken along the skeleton for the input seedling. The walk may start from the root tip of a seedling and may detect the width of the seedling for each step. For example, the root tip may be the furthest terminal point from the gravity center of the seedling. The path of the walk is defined by the skeleton of the seedling, adjacent steps move from one point on the skeleton to a neighbor which has not yet been visited. The walk may stop just before entering the cotyledon area where the width of the seedling typically exceeds a threshold value. At each crossing point for a branch in the skeleton, the walk only selects one path. Therefore, if at least a predetermined portion (e.g., 30%) of the skeleton has not been visited by the walk, the image may include overlapping seedlings. If Rule 1 is true, further overlap processing may be activated.

To check for Rule 2, seed coats directly connected to the seedling may be counted. If the number of seed coats is more than one, the image may include overlapping seedlings. The seed coat color marked in the segmentation step may be used to detect the number of seed coats. If Rule 2 is true, further overlap processing may be activated. If neither Rule 1 nor Rule 2 is true, no overlapping seedlings were detected and further overlap processing may not be required. The various aspects of FIG. 5 described herein may be implemented through hardware, software, firmware, or combinations thereof.

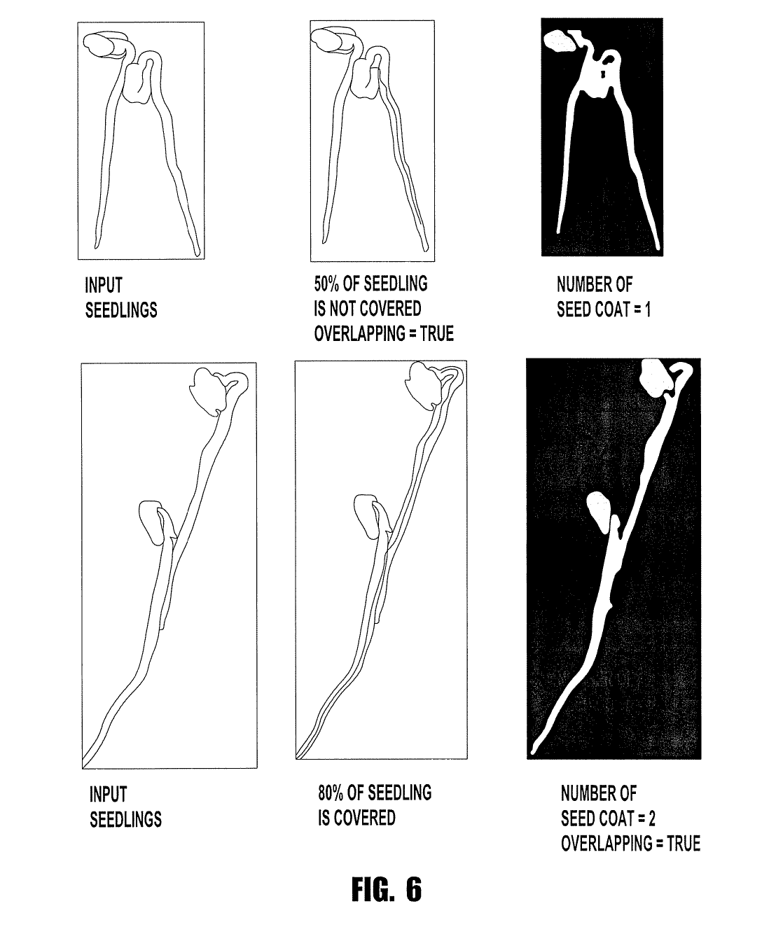

Examples of overlapping seedlings are shown in FIG. 6. The overlapping seedlings in the first row of images in FIG. 6 were detected under Rule 1 due to an unacceptable amount of branching. The overlapping seedlings in the second row were detected under Rule 2 due to multiple seed coats. If only Rule 1 is used, false negative errors (e.g., Rule 1 being false when actual overlapping is present) may occur if two overlapping seedlings are aligned such that there is only a small amount of branching. For example, the walk along the skeleton may visit most of the skeleton (see the second row in FIG. 6). Similarly, if only Rule 2 is used, false negative errors (e.g., Rule 2 being false when actual overlapping is present) may occur if any seed coat is sloughed off by a cotyledon (see the first row in FIG. 6). For example, counting seed coats may not give a precise estimate of the number of seedlings. Combining the two rules may improve the accuracy or precision of overlap detection by reducing the amount of false negative errors. The various aspects of FIG. 6 described herein may be implemented through hardware, software, firmware, or combinations thereof.

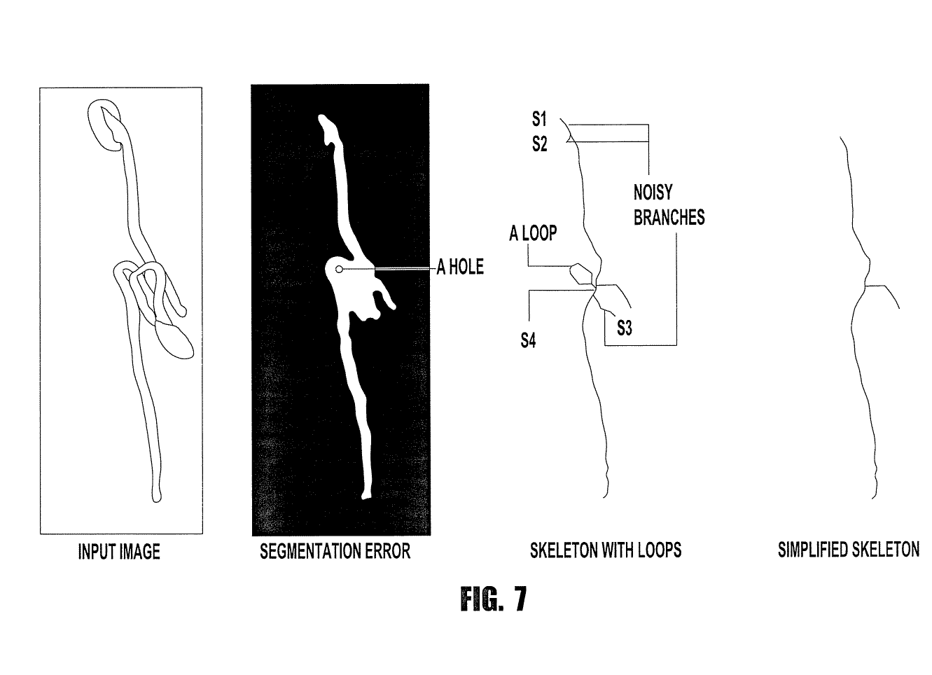

Network pruning can also be referred to as network simplification. Network pruning may eliminate noisy small segments and false loops and reduce overlap processing time. Noisy branches are branches that do not correspond to normal growth of seedlings and may be caused by segmentation errors. A segmentation error, for example, may exist if, after segmentation, an actual portion of the seedling is mistakenly classified as one or more background pixels or vice versa. In the segmentation stage of preprocessing, a global threshold was used to obtain a real-time response. However, even when a unique threshold is chosen for each image, errors can still occur. FIG. 7 gives such an example. Noisy branches make overlapping cases more difficult to solve and typically increase processing time for separation of the seedlings.

Deleting noisy branches typically reduces overlap processing time. Noisy branches may be deleted, for example, when both of the following conditions are true: i) the length of the segment sᵢ is less than a predetermined minimum threshold (condition 1) and ii) one terminal point of segment s₁ does not connect to another segment (condition 2).

With reference to FIG. 7, segments s₁, s₂, and s₃ may be identified as noisy segments and may be deleted from the skeleton. Condition 1, for example, may select segments (e.g., segments s₁, s₂, s₃, and s₄) that are short enough to be considered noisy segments (e.g., segments s₁, s₂, s₃, and s₄). Condition 2 may prevent identification of interconnecting short segments (e.g., segment s₄) as a noisy segment while permitting non-interconnecting short segments (e.g., segments s₁, s₂, and s₃) to be deleted. The resulting simplified skeleton from network pruning is shown in FIG. 7.

Another problem of a global threshold can be holes in seedlings that create loops in skeletons. A seedling hole is present when some background pixels are enclosed by foreground (i.e., seedling) pixels. Holes, for example, may be caused by a relatively dark area inside the cotyledon or by sharp curves that cause a first portion of a seedling to overlap or touch a second portion of the same seedling. In FIG. 7, there is an example of a skeleton with a loop that may be deleted.

To delete a skeleton loop, the pixels defining the hole may be adjusted. To accomplish this, a series of image processing steps may be taken. First, the black (i.e., background pixels) and white (i.e., seedling pixels) image may be reversed so that, for example, the black pixels are white and the white pixels are black. The hole may be detected by identifying small white areas in the image. Pixels defining the detected holes may be changed to black and the black and white image may be reversed again. At this point, the original seedling pixels are returned to white and the previous black hole is also white. A simplified skeleton may be derived from the pruned image. As shown in FIG. 7, the simplified skeleton does not include the loop caused by the hole.

In summary, loops and noisy branches can change the seedling structure in unexpected ways that may increase processing time and may cause incorrect solutions or unsolvable overlapping cases. Therefore, it is useful to remove loops and noisy branches from the skeleton. The various aspects of FIG. 7 described herein may be implemented through hardware, software, firmware, or combinations thereof.

The image processing algorithm described herein may also include network optimization in the overlap processing stage. In other words, of various possible separations of the network of segments that define the skeleton, the algorithm may select the most likely separation based on certain predetermined evaluation functions.

An overlap processing function, (e.g., ProcessOverlapping), for example, is shown below and may take segments s₁, s₂, . . . sₙ as input and may output a likely separation based on the highest evaluation score. “m” is the number of seed coats. The number of seed coats, for example, may be obtained after the segmentation stage by counting seed coats directly connected to the skeleton or within a seedling image associated with the skeleton.

```
ProcessOverlapping (s₁,s₂,..sₙ)
  Initialize maxv to 0
  loop 1: m=MAX(number of seed coats, 2)
    loop 2:
    call AssignLabels
      Assign segments s₁,s₂,..sₙ into m groups: g₁, g₂, ... gₘ. sᵢ can
      be assigned to multiple groups or can be left unused.
    for each group gⱼ call CheckConnectivity(gⱼ)
      gⱼ fails the test when segments belonging to gⱼ are not connected
      and or create branches. Skip 2.3 if gⱼ failed.
    v =Evaluation(g₁, g₂, gₘ)
      If v is larger than maxv, v→maxv
  end of loop 2
  if maxv<=0, which indicating that no optimal solution is found:
    if m>n, exit.
    else increase m by one, goto loop1
  otherwise return maxv
end of loop 1
```

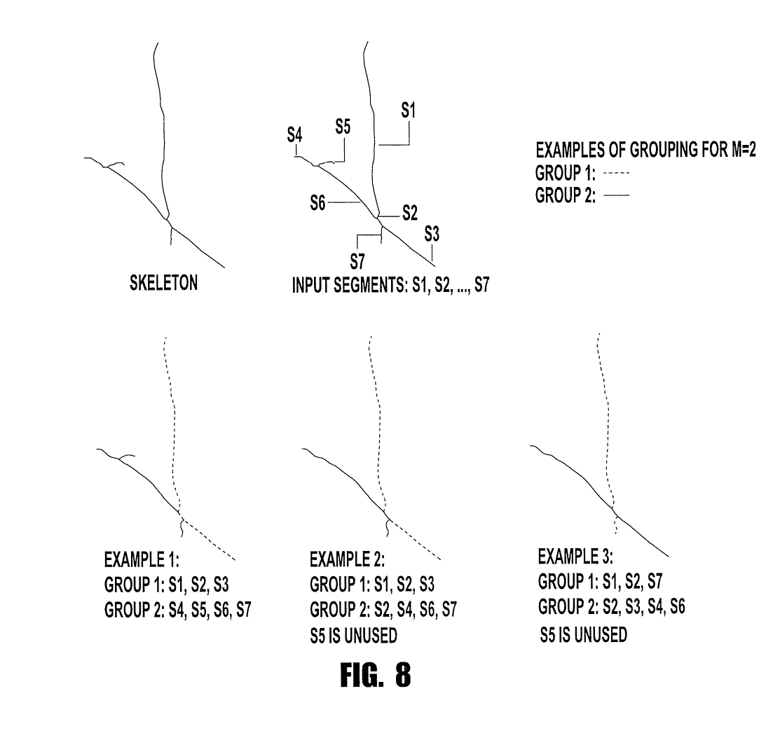

A separation function (e.g., AssignLabels), for example, provides various possible separations of the input segments. The segments are assigned into ‘m’ groups. Segments belonging to one group are assembled into one of the ‘m’ seedlings. A segment may remain unused or belongs to several groups. FIG. 8 gives three examples of network separations. In example 1, all segments are divided into two groups and no segment is shared. In example 2 and example 3, s5 is not used and s2 is shared by the two groups.

An “is connected” check function (e.g., CheckConnectivity), for example, may test whether the segments assigned to a seedling are connected. This is a quick test to avoid processing possible separations of input segments in which one or more possible groups of segments are not contiguous or otherwise connected. This test may reduce overlap processing time if any possible separations are eliminated. In FIG. 8, Example 1 does not pass this test because the segments of group 2 are not connected (i.e., segment s₇ does not connect to segments s₄, s₅, or s₆). Under these circumstances, the possible separations associated with Example 1 will be discarded and will not be passed to the Evaluation function. Conversely, Example 2 and Example 3 of FIG. 8 would be evaluated further. The various aspects of FIG. 8 described herein may be implemented through hardware, software, firmware, or combinations thereof.

Function Evaluation, for example, may be run on each possible separation and the separation with the highest evaluation score may be selected as the solution. The solution is a separation of overlapping seedlings into individual seedlings that is most likely to identify the actual individual seedlings that are overlapping.

$$evaluation = {\sum }_{k = 1 … m} {W}_{f} \cdot {f}_{k} + {W}_{g} \cdot {g}_{k} + {W}_{h} \cdot {h}_{k} - {W}_{I} \cdot {I}_{k} \qquad ( 1 )$$

The Evaluation function may be based on various parameters representing knowledge of seedling growth patterns. For example, a parameter may represent knowledge that seedlings do not turn in certain manners or that seedlings tend to overlap at similar lengths. The exemplary parameters for the Evaluation function are provided below:

$$\begin{matrix}{f}_{k} = {\sum }_{{i , j are neighbors}_{and both in group k}} Angle ( {segment}_{i} , {segment}_{j} ) & ( 2 ) \\ {g}_{k} = {Min}_{{i , j are neighbors}_{and both in group k}} ( Angle ( {segment}_{i} , {segment}_{j} ) ) & ( 3 ) \\ {h}_{k} = \frac{{\sum }_{i ∈ group k} Length ( {Seedling}_{i} )}{m \cdot {Max}_{j ∈ group k} ( Length ( {seedling}_{j} ) )} & ( 4 ) \\ {I}_{k} = Num Of Unused Segments ( {s}_{1} , {s}_{2} , … {s}_{k} ) & ( 5 )\end{matrix}$$

Parameter fₖ, for example, selects two neighboring or connected segments (e.g., segments sᵢ and sⱼ) and may identify the angle formed by the connection. Segments sᵢ and sⱼ belong to the same group of segments associated from a certain possible separation into multiple groups. If the returned angle is valid, it is normalized to (0, 180), the smaller the angle, the sharper the turn.

Parameter gₖ, for example, returns the minimum angle formed by all neighboring segments that belong to a particular group of segments. Together, parameters fₖ and gₖ may drive a possible separation to not be selected if, for example, one or more individual seedlings for that separation have a particularly sharp turn that is not likely to actually occur. For example, if a large value is determined for parameter fₖ and parameter gₖ returns a value larger than 90, it may be concluded that the seedling does not include sharp turns.

Parameter hₖ, for example, may be used to drive selection of possible separations to a separation in which the individual seedlings have similar lengths. This may be added based on an observation that overlapping seedlings tend to have similar lengths.

Parameter Iₖ, for example, may represent a number of unused segments for a particular separation. A penalty may be associated with each unused segment.

The Evaluation function may be a weighted sum of the individual parameters. Larger weights may be given to fundamental parameters, such as parameters fₖ and gₖ. Smaller weights may be given to less significant parameters, such as parameter hₖ. For example, if the seedling image has multiple possible separations that have similar results from the “no sharp turn” parameters, a separation in which the lengths of the individual seedlings are more similar lengths may be selected based on the score from the Evaluation function.

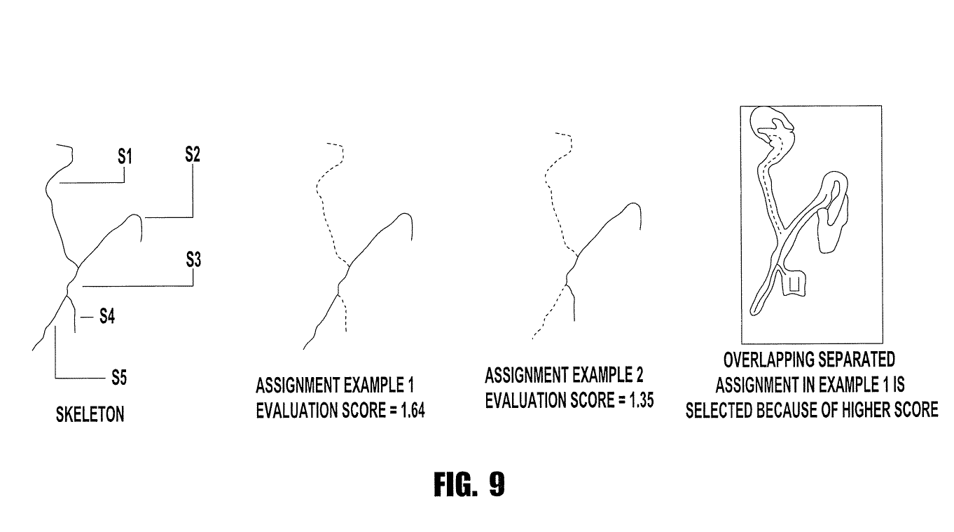

With reference to FIG. 9, an example of image processing using the Evaluation function shows the results for two possible separations for an image having overlapping seedlings. Assignment example 1 shows a first possible separation and assignment example 2 shows a second possible separation. The corresponding scores given by the Evaluation function are 1.64 for the first separation and 1.35 for the second separation. The image processing system selects the higher evaluation score and the corresponding results showing separation of the overlapping seedlings is shown in FIG. 9. Even though both cases are reasonable, the overlapping algorithm determines the preferred or most likely separation. This example demonstrates the advantage and flexibility of the image processing system. It makes decisions intelligently based at least in part on knowledge of parameters influencing the Evaluation function. Customization of the Evaluation function to incorporate further knowledge of common parameters associated with seedling growth patterns for all types of crops and unique parameters associated with certain types of crops is permitted and would be expected. The various aspects of FIG. 9 described herein may be implemented through hardware, software, firmware, or combinations thereof.

To further improve speed, heuristic knowledge can be used to assist overlapping analysis for cases when three or more seedlings overlap. This may include preprocessing of segments to extract as many seedlings as possible based on knowledge of overlap patterns. This preprocessing may consider local information which does not take much time. Further, processing time may be reduced by running the image processing algorithm on an n-overlap case instead of a n+1 (or more)-overlap case because the number of groups to be evaluated may be less. In addition, if the number of segments being evaluated is reduced, there may be a further reduction in processing time. To provide more efficient and more accurate processing, knowledge of typical overlap patterns may be collected beforehand. For example, one possible overlap pattern may be recognized when there are four segments forming a cross shape. In this example, it may be reasonable to conclude the segments belong to two seedlings crossing each other perpendicularly without performing certain portions of the image processing algorithm.

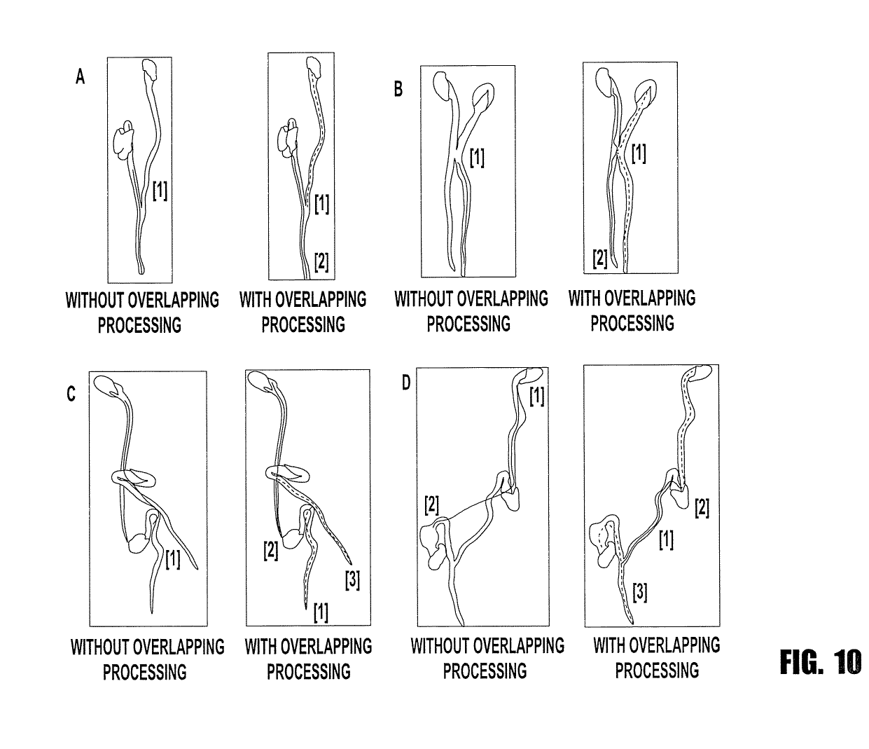

FIG. 10 provides examples of results using the overlap processing algorithm described herein. The figure includes an arrangement of four pairs of images, A, B, C, and D. The image on the left in each pair is an output of a soybean system described in Hoffmaster, 2002 that did not perform overlap processing. The overlaid dark lines reflect the incorrect single seedling measurement. The image on the right in each pair is an output after applying the overlap processing algorithm described herein on the same set of seedlings. Each seedling is given a different line style. It can be seen that overlapping seedlings were appropriately separated. Image pairs 10A and 10B are examples of cases with two overlapping seedlings while image pairs 10C and 10D are examples of cases with three overlapping seedlings. The various aspects of FIG. 10 described herein may be implemented through hardware, software, firmware, or combinations thereof.

Using the approach described herein for 95 sample cases, the image processing algorithm correctly identified 93% of the two overlapping seedling cases. Processing time of a two overlapping seedling case, for example, may be approximately 12 ms per pair. For example, there may be five pairs of overlapping seedlings in a group of imaged seedlings. Separating the five pairs of overlapping seedlings into individual seedlings may take approximately 60 ms of additional processing time. The average time for processing a given seedling image may normally take 2 seconds. Performing the overlap processing algorithm may increase the processing time for a given seedling image by a factor of 0.05% on average.

The image processing algorithm described herein is global and can be used for any type of crop because various possible separations of overlapping seedlings compete and a preferred solution is selected. The algorithm reduces propagation of errors because choices are made all at once instead of basing a choice on previous choices. Additionally, the algorithm tolerates noisy branches caused by, for example, segmentation errors or exposed cotyledons. A skeleton clean-up operation may be used to reduce potential noisy branches and process loops making the algorithm more robust.

The image processing algorithm separates overlapping seedlings and provides fast, objective, and reproducible readings. It is practical for commercial use because it can save a large amount of time previously spent on manually processing overlapping seedlings. For example, one typical example of two or three overlapping seedlings may take about 20 seconds to correct by a human analyst. There may be three or four overlapping seedlings encountered in a group of imaged seedlings. Accordingly, the image processing algorithm may save more than one minute per group of imaged seedlings. In a seed testing laboratory where hundreds or even thousands of samples are run each day, this can provide a substantial time savings. Additionally, where overlapping separation is done by the image processing algorithm rather than by seed analysts, measurement of the seedlings is more objective and the vigour index value is more standardized from laboratory to laboratory.

Although the success of the image processing algorithm was demonstrated using cotton seedlings, the same principles are applicable to other crops. Because the algorithm is general, it can function successfully regardless of the seed type. The framework of the image processing system is flexible and can accommodate further enhancements. As the algorithm is applied to other crops, the evaluation functions and pre-processing modes may be adjusted to typical colors, seedling sizes, growth patterns, and other characteristics of the crop. The image processing algorithm speeds evaluation of seedlings, makes separation of overlapping seedlings more objective, and improves seed testing standardization.

While the invention is described herein in conjunction with one or more exemplary embodiments, it is evident that many alternatives, modifications, and variations will be apparent to those skilled in the art. Accordingly, exemplary embodiments in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof. Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provisions of 35 U.S.C. § 112, ¶ 6.

1. A method of processing a source image of at least one seedling, each seedling being associated with a type of crop, the method including:
a) segmenting the source image into at least a foreground portion and a background portion to form a first segmented image, the foreground portion relating to the at least one seedling;
b) skeletonizing the first segmented image to form a first skeletonized image, the first skeletonized image including a skeleton relating to the foreground portion of the first segmented image;
c) dividing the skeleton in the first segmented image into a plurality of segments;
d) identifying alternate separations of the skeleton, each alternate separation including at least two groups, each group including at least one segment and potentially relating to a individual seedling; and
e) evaluating a plurality of the alternate separations as a function of at least one of: 1) individual angles defined by connecting segments of corresponding groups, 2) combined angles defined by connecting segments of corresponding groups, 3) length defined by connecting segments of corresponding groups, and 4) unused segments.

2. The method of claim 1, further including:
f) selecting a specific separation from the plurality of alternate separations based at least in part on the evaluating in e).

3. The method of claim 2, further including:
g) identifying at least two individual seedlings in the source image, the quantity of individual seedlings corresponding to the quantity of groups in the specific separation selected in f).

4. The method of claim 1, further including:
f) selecting a path from a first terminal point of the skeleton to a second terminal point, the path traversing at least a first portion of the skeleton and defining a second portion of the skeleton not traversed by the path; and
g) if the second portion is greater than or equal to a predetermined threshold, continuing to process the source image.

5. The method of claim 1, further including:
f) segmenting the foreground portion to identify one or more foreground areas in the foreground portion, each foreground area potentially relating to a corresponding seed coat associated with the type of crop; and
g) if more than one foreground area is identified, continuing to process the source image.

6. The method of claim 1, further including:
f) selecting a path from a first terminal point of the skeleton to a second terminal point, the path traversing at least a first portion of the skeleton and defining a second portion of the skeleton not traversed by the path;
g) segmenting the foreground portion to identify one or more foreground areas in the foreground portion, each foreground area potentially relating to a corresponding seed coat associated with the type of crop; and
h) if the second portion in f) is less than a predetermined threshold and less than two foreground areas are identified in g), discontinuing further processing of the source image.

7. The method of claim 1, further including:
f) determining a length for each of one or more segments of the skeleton having at least one terminal point not connected to another segment; and
g) if the length of any segment determined in f) is less than a predetermined threshold, deleting the corresponding segment from the skeleton in conjunction with further processing of the source image.

8. The method of claim 1, further including:
f) identifying at least one loop in the skeleton;
g) wherein the foreground portion of the first segmented image is defined by pixels of a first color and the background portion of the first segmented image is defined by pixels of a second color, reversing the first and second colors of pixels in the first segmented image to form a second segmented image in which the foreground portion is represented by pixels of the second color and the background portion is represented by pixels of the first color;
h) identifying one or more independent contiguous area of pixels of the first color in the second segmented image;
i) for each contiguous area smaller than a predetermined threshold, changing the pixels of the corresponding contiguous area from the first color to the second color to form a third segmented image;
j) reversing the first and second colors of pixels in the third segmented image to form a fourth segmented image in which the foreground portion is represented by pixels of the first color and the background portion is represented by pixels of the second color; and
k) skeletonizing the fourth segmented image to form a second skeletonized image, the second skeletonized image including a skeleton relating to the foreground portion of the fourth segmented image.

9. The method of claim 1 wherein at least one segment is shared by at least two groups for at least one alternate separation identified in d).

10. The method of claim 1 wherein at least one segment is not associated with any group for at least one alternate separation identified in d).

11. The method of claim 1, further including:
f) testing segment connectivity for each group of one or more alternate separations identified in d); and
g) if segments associated with any group are not contiguous, deleting the corresponding alternate separation in conjunction with further processing of the source image.

12. The method of claim 1, further including:
f) processing the plurality of alternate separations evaluated in e) using the following function:
$$evaluation = {\sum }_{k = 1 … m} {f}_{k} + {g}_{k} + {h}_{k} - {I}_{k} ;$$
wherein fₖ relates to 1) of e), gₖ relates to 2) of e), hₖ relates to 3) of e), and Iₖ relates to 4) of e).

13. The method of claim 12, further including:
g) multiplying at least one of fₖ, gₖ, hₖ, and Iₖ in the evaluation function of f) by a predetermined weighting factor.

14. The method of claim 1, further including:
f) processing the plurality of alternate separations evaluated in e) using the following function:
$${f}_{k} = {\sum }_{{i , j are neighbors}_{and both in group k}} Angle ( {segment}_{i} , {segment}_{j} )$$
wherein fₖ relates to 1) of e).

15. The method of claim 1, further including:
f) processing the plurality of alternate separations evaluated in e) using the following function:
$${g}_{k} = {Min}_{{i , j are neighbors}_{and both in group k}} ( Angle ( {segment}_{i} , {segment}_{j} ) )$$
wherein gₖ relates to 2) of e).

16. The method of claim 1, further including:
f) processing the plurality of alternate separations evaluated in e) using the following function:
$${h}_{k} = \frac{{\sum }_{i ∈ group k} Length ( {Seedling}_{i} )}{m \cdot {Max}_{j ∈ group k} ( Length ( {seedling}_{j} ) )}$$
wherein hₖ relates to 3) of e).

17. The method of claim 1, further including:
f) processing the plurality of alternate separations evaluated in e) using the following function:
Iₖ=NumOfUnusedSegments(s₁,s₂, . . . sₙ)
wherein Iₖ relates to 4) of e).

18. A method of processing a source image of at least two overlapping seedlings, the method including:
a) segmenting the source image into at least a foreground portion and a background portion to form a first segmented image, the foreground portion relating to the at least two overlapping seedlings;
b) skeletonizing the first segmented image to form a first skeletonized image, the first skeletonized image including a skeleton relating to the foreground portion of the first segmented image;
c) dividing the skeleton in the first segmented image into a plurality of segments;
d) determining a length for each of one or more segments of the skeleton having at least one terminal point not connected to another segment;
e) if the length of any segment determined in d) is less than a predetermined threshold, deleting the corresponding segment from the skeleton in conjunction with further processing of the source image;
f) identifying alternate separations of the skeleton, each alternate separation including at least two groups, each group including at least one segment and potentially relating to an individual seedling; and
g) evaluating a plurality of the alternate separations as a function of at least one of: 1) individual angles defined by connecting segments of corresponding groups, 2) combined angles defined by connecting segments of corresponding groups, 3) length defined by connecting segments of corresponding groups, and 4) unused segments.

19. The method of claim 18, further including:
h) testing segment connectivity for each group of one or more alternate separations identified in f); and
i) if segments associated with any group are not contiguous, deleting the corresponding alternate separation in conjunction with further processing of the source image.

20. The method of claim 18, further including:
h) processing the plurality of alternate separations evaluated in g) using the following function:
$$evaluation = {\sum }_{k = 1 … m} {W}_{f} \cdot {f}_{k} + {W}_{g} \cdot {g}_{k} + {W}_{h} \cdot {h}_{k} - {W}_{I} \cdot {I}_{k}$$
wherein fₖ relates to 1) of g), gₖ relates to 2) of g), hₖ relates to 3) of g), Iₖ relates to 4) of g), W_{f} is a first weighting factor applied to fₖ, W_{g} is a second weighting factor applied to gₖ, Wₕ, is a third weighting factor applied to hₖ, and W_{I} is a fourth weighting factor applied to Iₖ.

21. A method of processing a source image of at least two overlapping seedlings, the method including:
a) segmenting the source image into at least a foreground portion and a background portion to form a first segmented image, the foreground portion relating to the at least two overlapping seedlings;
b) skeletonizing the first segmented image to form a first skeletonized image, the first skeletonized image including a skeleton relating to the foreground portion of the first segmented image;
c) dividing the skeleton in the first segmented image into a plurality of segments;
d) identifying alternate separations of the skeleton, each alternate separation including at least two groups, each group including at least one segment and potentially relating to an individual seedling;
e) testing segment connectivity for each group of one or more alternate separations identified in d);
f) if segments associated with any group are not contiguous, deleting the corresponding alternate separation in conjunction with further processing of the source image; and
g) evaluating a plurality of the alternate separations as a function of at least one of: 1) individual angles defined by connecting segments of corresponding groups, 2) combined angles defined by connecting segments of corresponding groups, 3) length defined by connecting segments of corresponding groups, and 4) unused segments.

22. The method of claim 21, further including:
h) determining a length for each of one or more segments of the skeleton having at least one terminal point not connected to another segment; and
i) if the length of any segment determined in h) is less than a predetermined threshold, deleting the corresponding segment from the skeleton in conjunction with further processing of the source image.

23. The method of claim 21, further including:
h) processing the plurality of alternate separations evaluated in g) using the following function:
$$evaluation = {\sum }_{k = 1 … m} {W}_{f} \cdot {f}_{k} + {W}_{g} \cdot {g}_{k} + {W}_{h} \cdot {h}_{k} - {W}_{I} \cdot {I}_{k}$$
wherein fₖ relates to 1) of g), gₖ relates to 2) of g), hₖ relates to 3) of g), Iₖ relates to 4) of g), W_{f} is a first weighting factor applied to fₖ, W_{g} is a second weighting factor applied to gₖ, Wₕ is a third weighting factor applied to hₖ, and W_{I} is a fourth weighting factor applied to Iₖ.

24. An apparatus, including:
a source image of at least one seedling, each seedling associated with a type of crop;
at least one storage device storing an image processing software application;
a processor in operative communication with the at least one storage device and adapted to run the image processing software application to: a) segment the source image into at least a foreground portion and a background portion to form a first segmented image, the foreground portion relating to the at least one seedling, b) skeletonize the first segmented image to form a first skeletonized image, the first skeletonized image including a skeleton relating to the foreground portion of the first segmented image, c) divide the skeleton in the first segmented image into a plurality of segments, d) identify alternate separations of the skeleton, each alternate separation including at least two groups, each group including at least one segment and potentially relating to an individual seedling, and e) evaluate a plurality of the alternate separations as a function of at least one of: 1) individual angles defined by connecting segments of corresponding groups, 2) combined angles defined by connecting segments of corresponding groups, 3) length defined by connecting segments of corresponding groups, and 4) unused segments.

25. The apparatus of claim 24 wherein the processor is adapted to run the image processing software application to: f) select a specific separation from the plurality of alternate separations based at least in part on the evaluating in e).

26. The apparatus of claim 25 wherein the processor is adapted to run the image processing software application to: g) identify at least two individual seedlings in the source image, the quantity of individual seedlings corresponding to the quantity of groups in the specific separation selected in f).

27. The apparatus of claim 24 wherein the processor is adapted to run the image processing software application to: f) select a path from a first terminal point of the skeleton to a second terminal point, the path traversing at least a first portion of the skeleton and defining a second portion of the skeleton not traversed by the path and g) if the second portion is greater than or equal to a predetermined threshold, continuing to process the source image.

28. The apparatus of claim 24 wherein the processor is adapted to run the image processing software application to: f) segment the foreground portion to identify one or more foreground areas in the foreground portion, each foreground area potentially relating to a corresponding seed coat associated with the type of crop and g) if more than one foreground area is identified, continuing to process the source image.

29. The apparatus of claim 24 wherein the processor is adapted to run the image processing software application to: f) determine a length for each of one or more segments of the skeleton having at least one terminal point not connected to another segment and g) if the length of any segment determined in f) is less than a predetermined threshold, deleting the corresponding segment from the skeleton in conjunction with further processing of the source image.

30. The apparatus of claim 24 wherein the processor is adapted to run the image processing software application to: f) test segment connectivity for each group of one or more alternate separations identified in d) and g) if segments associated with any group are not contiguous, delete the corresponding alternate separation in conjunction with further processing of the source image.
